(19) United States
(12) Patent Application Publication
(10) Pub. No.: US 2026/0145328 A1
(43) Pub. Date: May 28, 2026

(54) MULTI-PURPOSE MISSION PLANNER FOR ROBOT SWEEPER

(71) Applicant: ViaBot, Inc., Santa Clara, CA (US)

(72) Inventors: John Lee, Sunnyvale, CA (US); Raj Shinde, Santa Clara, CA (US); Yashaarth Todi, Santa Clara, CA (US)

(21) Appl. No.: 19/401,221

(22) Filed: Nov. 25, 2025

Related U.S. Application Data
(60) Provisional application No. 63/725,522, filed on Nov. 26, 2024.

(51) Int. Cl. B25J 9/16; B25J 11/00

(52) U.S. Cl. CPC B25J 9/1664; B25J 9/161; B25J 11/0085

(57) ABSTRACT

A method for autonomous navigation by a robot module is provided, including: receiving selection of a region of a map for coverage by the robot module; responsive to receiving the selection, then generating a path for traversal by the robot module, the path including one or more back-and-forth raster patterns that enable coverage of the region by the robot module; generating a plurality of waypoints along the path, the waypoints defining a sequence of target destinations for the robot module; autonomously moving the robot module through the waypoints in sequence, wherein moving the robot module through the waypoints causes the robot module to substantially traverse the path.

### CLAIM OF PRIORITY

This application claims priority to U.S. Provisional Application No. 63/725,522, filed on Nov. 26, 2024, entitled “MULTI-PURPOSE MISSION PLANNER FOR ROBOT SWEEPER”, which is herein incorporated by reference.

### RELATED APPLICATIONS

This application is related to U.S. patent application Ser. No. 17/134,102 filed on Dec. 24, 2020 and entitled “SYSTEMS FOR SETTING AND PROGRAMMING ZONING FOR USE BY AUTONOMOUS MODULAR ROBOTS,” and to U.S. Provisional Ser. No. 63/725,519 (Attorney Docket No. VBOTP006+), filed on Nov. 26, 2024 entitled “MULTI-LAYERED PLANNERS FOR CLOSE ADHERENCE TO EDGES BY A ROBOT SWEEPER,” and to U.S. Provisional Ser. No. 63/725,524 (Attorney Docket No. VBOTP008+), filed on Nov. 26, 2024, and entitled “2D MAP MANAGEMENT BY A ROBOT SWEEPER,” the disclosures of which are herein incorporated by reference.

### FIELD

The present disclosure relates generally to systems and methods for implementing a multi-purpose mission planner for a robot sweeper.

### BACKGROUND

Autonomous robots are becoming increasingly prevalent due to their ability to automatically perform a variety of tasks that are typically performed manually by humans, or that have been performed with direct human control of a machine. An example of an autonomous robot is a robotic sweeper which can be used to clean surfaces such as the parking surface of a parking lot. Such robots are often programmable, allowing users to configure operation times, frequency of operation, and various other settings for the robots. Once programmed, the robots may perform a task, move, and interact with the surrounding environment without requiring further human input. However, challenges remain in providing optimal autonomous navigation of a robot.

It is in this context that embodiments of the disclosure arise.

### SUMMARY

Methods, systems, and computer systems are provided for a multi-purpose mission planner for a robot sweeper.

Broadly speaking, in some implementations, a mission planner for a robot sweeper is provided allowing the robot to cater to large scale properties switching between a deep cleaning mode and a spot cleaning mode. In some implementations, a patrol path is provided whereby the robot travels around all edges of the property, which can be used for surveillance.

In some implementations, the spacing between alternating passes of a robot sweeper is adjustable for different modes of operation. Deep cleaning mode uses a close spacing, whereas spot cleaning mode uses a wide spacing. In another embodiment, the path width can be automatically and/or dynamically set (e.g. based on detected trash or obstacles).

In some implementations, a method for autonomous navigation by a robot module is provided, including: receiving selection of a region of a map for coverage by the robot module; responsive to receiving the selection, then generating a path for traversal by the robot module, the path including one or more back-and-forth raster patterns that enable coverage of the region by the robot module; generating a plurality of waypoints along the path, the waypoints defining a sequence of target destinations for the robot module; autonomously moving the robot module through the waypoints in sequence, wherein moving the robot module through the waypoints causes the robot module to substantially traverse the path.

In some implementations, a spacing between adjacent passes of the back-and-forth raster patterns is set according to a user-selectable operational mode of the robot module.

In some implementations, the robot module is configured to perform sweeping of a surface, and wherein the user-selectable operational mode is selected from a deep cleaning mode that sets a narrow spacing between the adjacent passes, and a spot cleaning mode that sets a wide spacing between the adjacent passes.

In some implementations, a spacing between adjacent passes of the back-and-forth raster patterns is dynamically set in response to detected surface conditions by the robot module, the detected surface conditions being of a local environment in which the robot module is disposed that is represented by the selected region of the map.

In some implementations, the dynamic setting of the spacing between the adjacent passes is configured so that when the detected surface conditions include higher amounts of debris, then the spacing is configured to be narrower, whereas when the detected surface conditions include lower amounts of debris, then the spacing is configured to be wider.

In some implementations, the spacing between the adjacent passes is configured to be at a default setting, and wherein the dynamic setting of the spacing is configured to adjust the spacing to be narrower than the default setting in response to the detected surface conditions indicating an amount of debris.

In some implementations, the detected surface conditions include a geographic region adjacent to a current pass being traversed by the robot module.

In some implementations, generating the waypoints includes assigning waypoints along straight portions of the path and along turns in the path.

In some implementations, the waypoints assigned along the straight portions have a first density, and wherein the waypoints assigned along the turns have a second density greater than the first density.

In some implementations, the method further includes providing a user interface through a display, wherein the selection of the region of the map is received through the user interface.

In some implementations, non-transitory computer readable medium is provided having program instructions embodied thereon that, when executed by at least one processor cause said at least one processor to perform a method for autonomous navigation by a robot module, the method including the following operations: receiving selection of a region of a map for coverage by the robot module; responsive to receiving the selection, then generating a path for traversal by the robot module, the path including one or more back-and-forth raster patterns that enable coverage of the region by the robot module; generating a plurality of waypoints along the path, the waypoints defining a sequence of target destinations for the robot module; autonomously moving the robot module through the waypoints in sequence, wherein moving the robot module through the waypoints causes the robot module to substantially traverse the path.

The foregoing is a summary of certain embodiments in accordance with implementations of the disclosure. It will be appreciated that other embodiments and implementations will be realized upon a full understanding of the present disclosure.

### BRIEF DESCRIPTION OF THE DRAWINGS

FIG. 1 illustrates a high level diagram of a robot module that is designed for a sweeping work function, in accordance with one embodiment.

FIG. 2 illustrates a two-dimensional map showing various path sections generated by the mission planner, in accordance with implementations of the disclosure.

FIG. 3 illustrates a map showing a path defined for a user-defined zone, in accordance with implementations of the disclosure.

FIG. 4 illustrates a map showing alternative paths having different path width spacing, in accordance with the implementation of FIG. 3.

FIGS. 5A and 5B illustrate a map with a path having a plurality of waypoints, in accordance with implementations of the disclosure.

FIG. 6 illustrates a map showing a test path for obstacle validation by a robot module, in accordance with implementations of the disclosure.

FIG. 7 conceptually illustrates componentry of a robot module, in accordance with implementations of the disclosure.

The drawings are provided to illustrate examples of embodiments and are not intended to limit the scope of the disclosure. In addition, features in the drawings are not necessarily to scale.

### DETAILED DESCRIPTION

Methods and systems for controlling operation by autonomous modular robots are disclosed. The methods include hardware and/or software systems that are used to interface with and control operation of an autonomous modular robot that is programmed to perform a task. Broadly speaking, the autonomous modular robot may be referred to by a number of names, such as, the robot (module), the modular robot, the (robot) sweeper, the scrubber, the autonomous vehicle, the vehicle, the cutter, the mower, the autonomous unit, and other similar names. The modular robot can therefore be configured to perform different tasks, or work functions. These tasks can include, without limitation, ground cleaning, floor source cleaning, ground scrubbing, ground vacuuming, sweeping of paved surfaces (e.g. parking lots, buildings, roads, etc.), or other types of outdoor or indoor surfaces or spaces. In one example, the modular robot may be configured for sweeping. Such a configuration may include a robot, a sweeper module, and a dock assembly.

The robot is mobile (e.g., has wheels or tracks), and is configured to engage and retain the sweeper module, and maneuver the sweeper module over a given surface to be cleaned. The sweeper module is a modular unit having brushes that sweep debris from the surface into an included collection container. If the work function is to scrub a surface, a scrubber module may be picked up by the robot instead of a sweeper module. The same applies to a mower module, which can be picked up from a respective docking station to enable mowing of a lawn, shrubs, or grass.

In the case of a robot that performs removal of trash or other debris from a surface (e.g. parking lot), close adherence to curbs and along walls or other structures at the edge of a surface is desirable, as debris tends to accumulate in such edge regions. It can be desirable to have sweeper brushes of the robot physically contact the curb in order to provide effective cleaning at the edge. However, if the robot encounters an obstacle such a parked car, it is desirable for the robot to avoid physical contact with the parked car, while also following a path that nonetheless closely hews to the external footprint of the parked car. In this manner, the robot sweeper can maximize cleaning along edges while also avoiding contact with obstacles.

These and other features described herein will now be further described with reference to the following drawings.

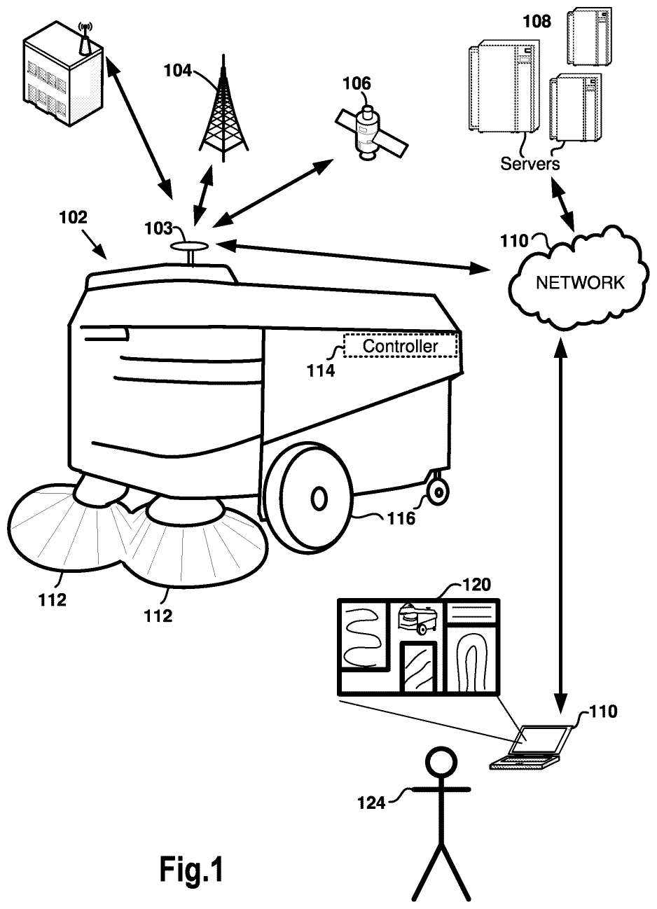

FIG. 1 illustrates a high level diagram of a robot module 102 that is designed for a sweeping work function, in accordance with one embodiment. As shown, the robot module 102 includes brushes 112, which are utilized to sweep debris collected from surfaces, such as parking lots, hard surfaces, buildings, and the like. In one embodiment, the robot module 102 includes a sweeping module (not shown) which is contained within the robot module 102, and the sweeping module is connected to the brushes 112. For more information on the modular interface between the robot module 102 and the sweeping module, reference may be made to U.S. Provisional Ser. No. 63/087,179, filed on Oct. 3, 2020, which is herein incorporated by reference. The robot module 102 includes one or more antenna 103, which is used by the robot module 102 to communicate wirelessly with one or more different types of communication devices. In one embodiment, the antenna 103 can include the communications device for communicating with the network 110.

The communications device can be an Ethernet controller that allows for Wi-Fi or cellular connection to the network 110. In some embodiments, high-speed cellular can be utilized for the communication, such as 5G communication. In some embodiments, the antenna 103 can be configured to communicate with a cell tower 104, or multiple cell towers 104 for enabling the communication with the network 110. In some embodiments, the GPS transponder can be provided in the robot module 102, to enable communication with a global positioning system (GPS) device 106. The robot module 102 may also communicate with local GPS 106a, for higher precision economist movement. Broadly speaking, GPS coordinates obtained from a GPS 106 may not provide sufficient precision and movement when the robot module 102 is required to perform fine tune movements, based on the work function.

The local GPS 106a, for example, may be installed at the location where the robot module 102 is to perform its work function. As mentioned above, mapping data can be generated for a location to enable the robot module 102 to move efficiently about the location in which the work function is to be performed. Network 110 is shown communicating with servers of a data center 108. The servers 108 may be replicated among one or more data centers depending on the location of the robot module 102 and the desired communication with those robots. For example, robot modules 102 operating in California may utilize local region data centers 108, and robot modules 102 operating in New York may utilize local region data centers 108 to reduce delay. As will be described in greater detail below, the servers of the data center may be utilized to communicate instructions to the robot modules 102. The instructions provided to the robot module 102 can include information for defining zones at specific locations, where the robot module 102 is to perform its work function.

The instructions can be custom tailored by the manager of the location where the robot module 102 is to perform its work function. In some embodiments, the manager is the user 124, which has access to a computer 110 for visualizing the location where the work function is to be performed. The user interface 120 may be provided which highlights the layout of the location, and allows for the user 124 to customize the zones to be used to perform the work functions. The robot module 102 is shown to include wheels 116 to enable the robot module 102 to function in its autonomous movement. The autonomous movement of the robot module 102 can be customized based on a schedule, and can be customized to allow the user 124 to define different work functions to be performed in different zones of a location being managed. The controller 114 of the robot module 102 includes electronics that provide for autonomous movement of the robot module 102, and interfacing with electronics of the sweeper module being used by the robot module 102.

The robot module 102 includes batteries to enable electric vehicle movement and operation, and the sweeper module included in the robot module 102 will also include batteries for providing power to perform the work function. In one embodiment, the robot module 102 is configured to be docked at a docking station, where the robot module and its batteries can be charged.

The robot module 102 uses one or more of a number of guiding technologies for autonomous movement, such as GPS, local GPS, cameras for vision assisted movement, LIDAR, radar, sonar, ultrasonic proximity sensors, depth cameras, or combinations of two or more thereof.

As described in further detail below, in some implementations, the robot module 102 includes a mission planner (also referred to as a coverage planner or path planner) that is used to define a path for the robot module to follow in order to traverse an area represented by a map (e.g. for sweeping/cleaning the area). Broadly speaking, the mission planner automatically determines the optimal path by subdividing an area in various sections, and further optimizing the path direction. The mission planner may further accept user-defined constraints and optimize the path subject to such constraints.

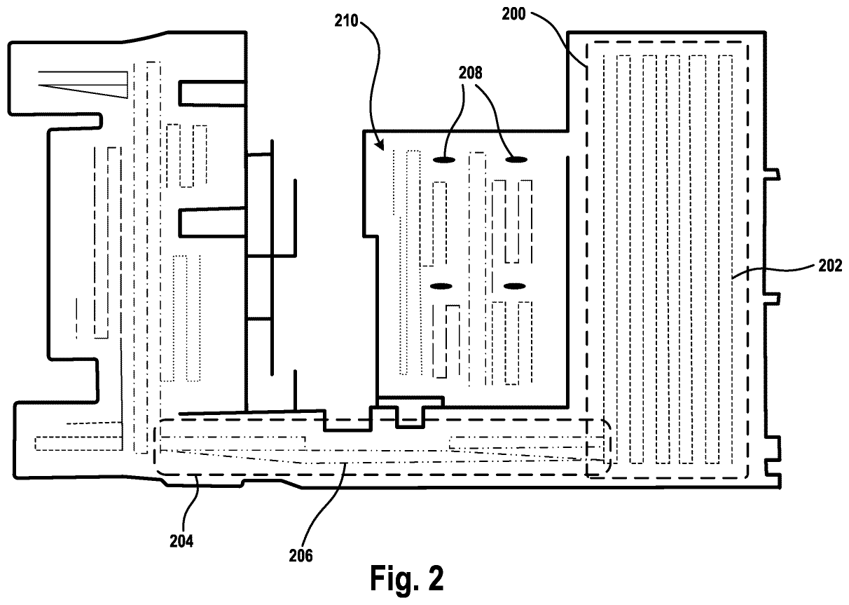

FIG. 2 illustrates a two-dimensional map showing various path sections generated by the mission planner, in accordance with implementations of the disclosure.

In some implementations, the mission planner is configured to divide a given area, such as that identified by a map, into multiple sections for traversal. In some implementations, this entails finding the fewest sections which will enable coverage of the entire map, with each section being traversed via a snake-pattern (or back-and-forth raster pattern or serpentine pattern). It will be appreciated that various sections of raster traversal can be necessitated by the existence of various obstacles or contours of the mapped area.

Further, in some implementations, the mission planner is configured to find the optimal direction (or raster angle) for a given section. That is, the mission planner is configured to find the raster angle that allows for the given section to be fully traversed via a back-and-forth raster pattern with the fewest turns. In other words, the planned route of a given section is oriented along the longest side of the section to minimize the number of turns or the amount of turning.

With the above in mind, in some implementations, the mission planner is configured to optimally design a path for a given map area by finding the path that minimizes the total amount of turning of the robot module required (e.g. as defined by number of turnarounds of the raster pattern, or amount of angular change in direction), while also utilizing a back-and-forth raster traversal pattern to traverse portions of the map. In so doing, the mission planner may discover various sections of raster traversal and define these as separate sections of the map, and link the traversal paths from one section to another in order to provide a complete traversal path for the map area. In minimizing the amount of turning, the mission planner finds the optimal raster angle or orientation of raster traversal of each section.

With continued reference to FIG. 2, in the illustrated map, various path sections are shown, as created by the mission planner. For example, a section 200 of the map is traversed by a path portion 202, which as shown has a raster angle oriented substantially vertically in the illustrated view of the map. Whereas a section 204 is traversed by a path portion 206, which as shown has a raster angle oriented substantially horizontally in the illustrated view of the map. As can be seen, the direction of traversal or raster angle is optimized for each section so as to minimize turning while providing full coverage of the section.

It will be appreciated that few or many sections may be required for a given region of the map. For example, in the region 210 of the map, a variety of sections have been defined due to the presence of various obstacles, such as obstacles 208, requiring a number of traversal path portions in order to fully cover the region 210.

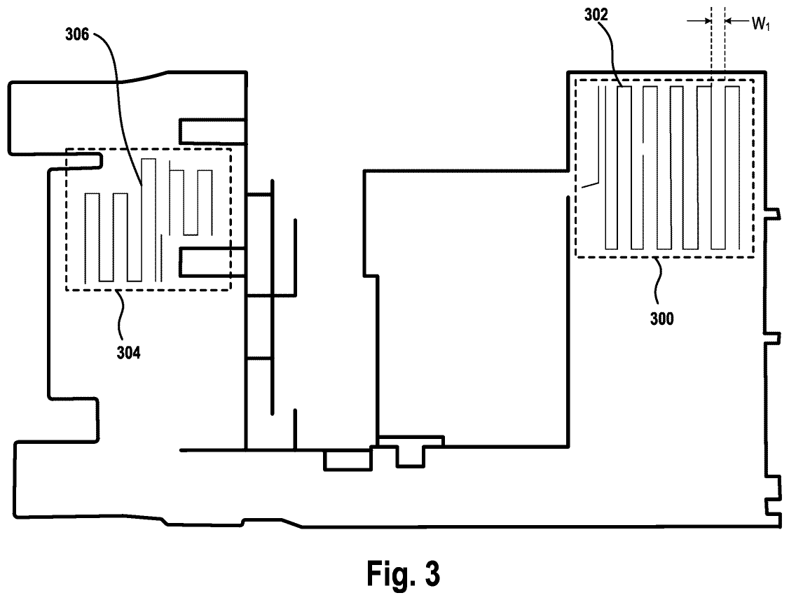

FIG. 3 illustrates a map showing a path defined for a user-defined zone, in accordance with implementations of the disclosure.

In some implementations, a user can define a zone or area of a given map for traversal by the robot module (e.g. a specific zone or area for cleaning by a robot sweeper). For example, a user interface can be provided that enables a user to draw/select or otherwise define a geographical portion of a map for traversal by the robot module. In the illustrated implementation, a zone 300 and a zone 304 of the map have been selected for traversal by the robot module. Accordingly, in response to the selection of these zones, the mission planner has created a path 302 for the robot module to traverse the zone 300, and also created a path 306 for the robot module to traverse the zone 304. The paths have been optimized to provide maximum coverage of the respective zones while minimizing the number of turns for efficiency in accordance with the principles of the present disclosure as discussed.

In some implementations, the path width, or the distance between two consecutive parallel paths (i.e. distance between parallel paths aligned along the raster angle) is adjustable, and may be set by the user or in accordance with predefined settings. As shown at FIG. 3, the path width W₁ is configured at a relatively narrow spacing/distance.

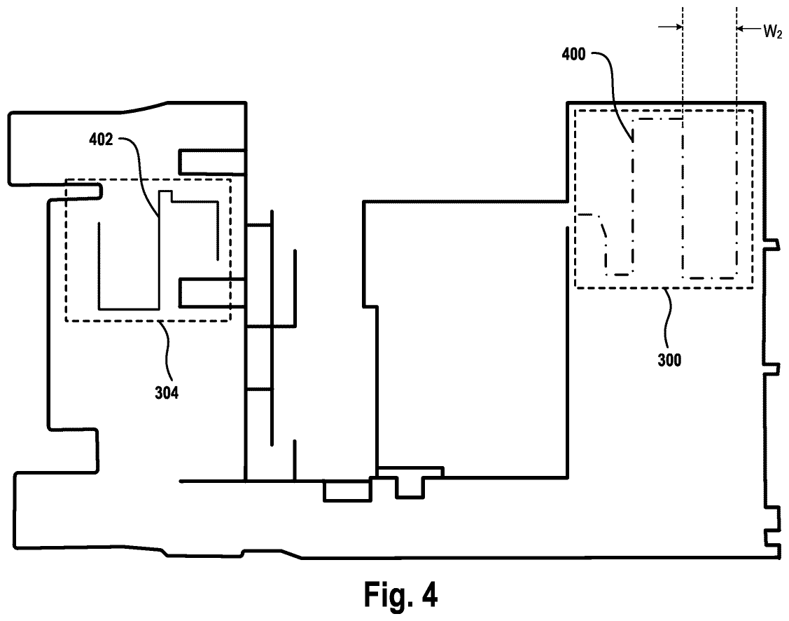

FIG. 4 illustrates a map showing alternative paths having different path width spacing, in accordance with the implementation of FIG. 3.

As shown at FIG. 4, the paths 400 and 402, which have been created for the same zones 300 and 304, respectively, have a path width W₂ configured with wider spacing/distance as compared to those of FIG. 3.

It will be appreciated that that path width can be set at different widths depending on the user's preference or the application of the robot module.

In some implementations, the robot module is configured as a robot sweeper/cleaner with different modes of operation which provide varying levels of cleaning. For example, a deep cleaning mode can be defined in which the path width is set at a narrow setting, so that the parallel paths are defined (by the mission planner) with close spacing to provide thorough coverage when cleaning an area. In some implementations, the path width is set to be approximately at the effective cleaning width of the robot sweeper (e.g. width that is swept by the robot sweeper during a single pass), so that substantially all portions of the area are swept/cleaned at least once. In some implementations, the path width is set to be less than the effective cleaning width of the robot sweeper, so that there is overlap between the areas cleaned by adjacent parallel passes of the robot sweeper. In some implementations, the path width is set at about one-half the effective cleaning width of the robot sweeper. In this manner, areas cleaned by adjacent parallel passes of the robot sweeper overlap by about 50%, so that most portions of an area being cleaned (e.g. excepting certain regions at the edges of the area) are passed over twice by the robot sweeper.

As another example of an operational mode, a spot cleaning mode can be defined for which the path width is defined having a relatively wide spacing. In some implementations, the path width is set to be greater than the effective cleaning width of the robot sweeper.

In some implementations, the path width can be automatically set and/or dynamically set/adjusted based on real-time detected conditions by the robot sweeper.

For example, in some implementations, during spot cleaning mode, when debris is detected in an adjacent region that will not otherwise be covered by the robot sweeper as it travels according to the nominally defined path width, then the path width for a subsequent pass is adjusted so as to enable the robot sweeper to pass over the detected debris. For example, if the path width is too wide to enable coverage of the debris, the path width can be automatically reduced to enable the robot sweeper to pass over the debris. Following traversal according to the reduced path width, then in some implementations, the robot sweeper returns to travel utilizing the nominal path width defined for the spot cleaning mode.

In some implementations, the path width is dynamically set based on detection of debris. For example, as the robot sweeper travels along a current linear pass, then the path width for the next adjacent pass is dynamically determined so as to cover any detected debris flanking or laterally positioned relative to the current pass. In this manner, the path width may be dynamically wider or narrower depending upon the amount of debris that is detected by the robot using its sensors. In some implementations, the path width is dynamically configured to be inversely correlated to the amount of debris detected. That is, as more debris is detected, then the path width is dynamically set to be narrower (which may also increase an amount of overlap between adjacent passes), whereas when less debris is detected, then the path width is dynamically set to be wider (which may also reduce the amount of overlap between adjacent passes).

It will be appreciated that in some implementations, the robot sweeper may have a lateral detection range within which the robot sweeper scans and detects debris using its various sensors, and accordingly if no debris is detected within this range during a current pass, then the path width can be dynamically set so that the next adjacent pass is approximately at the edge of the detection range, enabling the robot sweeper to capture any debris that might be at the edge or just outside of the prior scanned area, and enabling detection of a subsequent adjacent area according to its lateral detection range. Whereas if debris is detected within the lateral detection range, then the path width is dynamically set to enable cleanup of the debris by configuring a subsequent pass to cover the location of the debris.

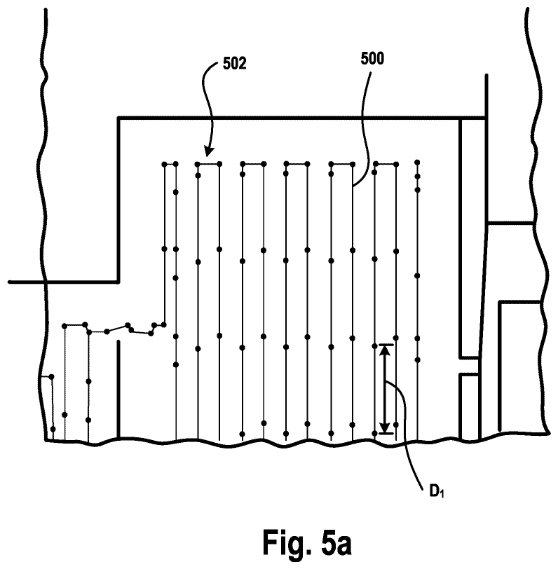

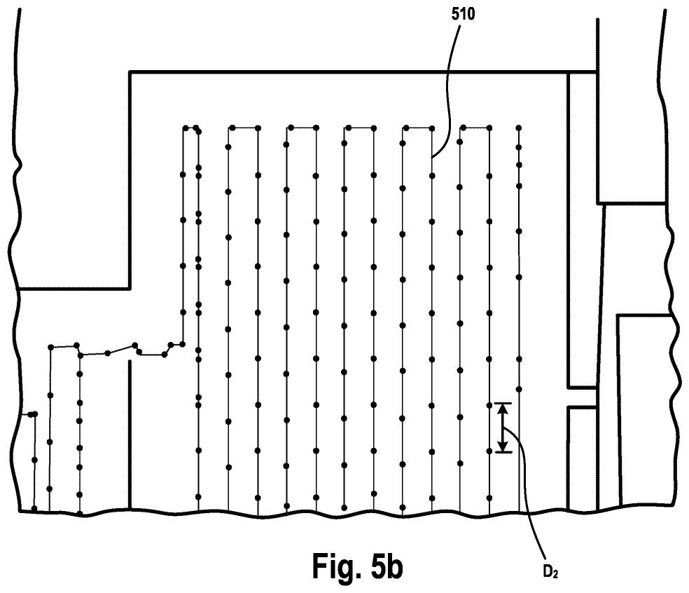

FIG. 5 illustrates a map with a path having a plurality of waypoints, in accordance with implementations of the disclosure.

In some implementations, when a path has been generated by the mission planner, then various waypoints are defined at regular intervals along the path. The waypoints define specific locations for the robot module to navigate to in accordance with the path, so that by navigating the series of waypoints in sequence, the robot module will thereby follow, at least approximately, the path that has been planned.

As shown in the illustrated implementation, a path 500 has been planned in the map, and various waypoints, represented by dots along the path 500, have been defined along the path 500. In some implementations, the waypoint density is defined by setting the nominal distance between waypoints at a distance D1.

In some implementations, the density of waypoints may deviate from the nominal distance at certain non-linear portions of the path, such as at turns or curves in the path. For example, in the illustrated implementation, waypoints are defined at the turnaround portion 502 of the path 500, and more specifically at the corners of the turns in the path. These waypoints do not adhere to the nominal waypoint density setting, but are defined so as to provide waypoints which will enable the robot module to accurately adhere to the path 500 at such a portion of the path.

In some implementations, the waypoint density is adjustable based on conditions or in accordance with a user-defined setting.

FIG. 5B illustrates a map showing a path with waypoints defined thereon, in accordance with implementations of the disclosure.

In the illustrated implementation of FIG. 5B, a path 510 is shown that is similar to that of FIG. 5A. However, along the path 510, waypoints are shown (as dots), having a higher density setting such that the nominal distance D₂ between waypoints is set to be less than that of the implementation of FIG. 5A. By providing a higher density of waypoints, the path can be more closely followed by the robot module.

For example, in some implementations, the robot module may need to dynamically adjust its path of travel in order to avoid an obstacle that is not accounted for in the map. When doing so, the robot module will deviate from the intended path and skip one or more waypoints, but can be configured to return to the next available waypoint. In such instances when it is necessary to skip one or more waypoints, then with a higher density of waypoints available, the robot module will more closely follow the original path than if a lower density of waypoints is provided.

In some implementations, the waypoint density is set according to a user-defined preference. In some implementations, the waypoint density is automatically set based on one or more factors, such as the lengths of parallel path portions, the path width between adjacent parallel path portions, etc. In some implementations, waypoint density may vary based on the contour of the path, such that waypoint density increases as the contour of the path becomes less linear.

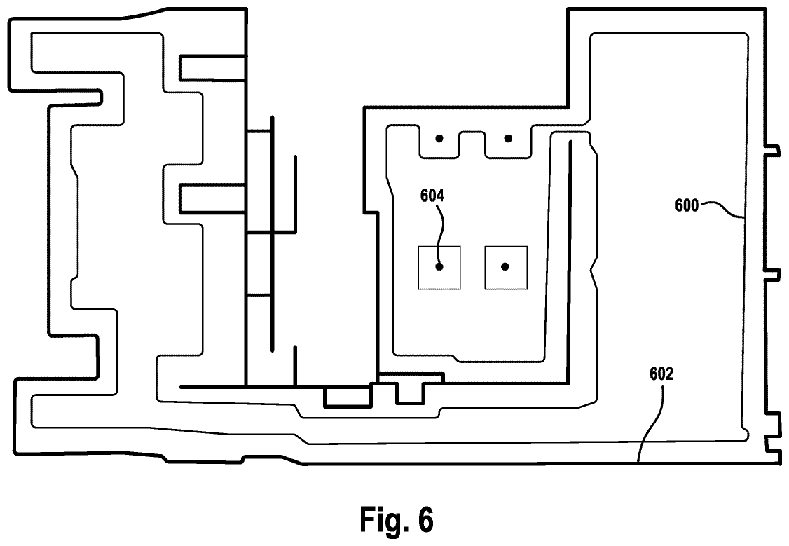

FIG. 6 illustrates a map showing a test path for obstacle validation by a robot module, in accordance with implementations of the disclosure.

In some implementations, deployment of a robot module to a particular location or property can include a validation process in order to validate contents of a map of the location/property. As part of this process, the robot module may be operated in an obstacle validation mode, and accordingly, the mission planner can prepare a path only around boundaries of obstacles, so as to validate the obstacles shown in the map. As used herein, the obstacles include any permanent objects or structures that would be expected to block the movement of the robot module on an ongoing basis, and can include items such as walls, curbs, pillars, parking bumpers/blocks, fencing, railings, etc.

In the illustrated implementation a path 600 has been defined on the illustrated map according to the obstacle validation mode of operation. The path 600 is configured to enable validation of obstacles with minimal travel. For example, the path 600 as shown is configured to travel along walls/curbs 602, and travel around other obstacles such as obstacles 604. In some implementations, the obstacle validation mode is configured to generate a path configured to be at a predefined distance from any obstacles if possible, with the predefined distance being within the range of the robot module's scanning capabilities.

In some implementations, the robot module further includes a recognition capability to recognize objects that are sensed during the validation process, and also distinguish between objects of a permanent nature and objects of a temporary nature (e.g. parked car). In some implementations, if any new objects of a permanent nature are discovered that were not already present on the map, then the map can be updated to reflect the presence of these objects, whereas any discovered objects of a temporary nature can be ignored.

In a related implementation, a patrol path can be defined for the robot module in order to provide surveillance of a property. For example, the patrol path may consist of a path around the edges of the property, such as a path defined at a predefined distance from the edges of the property. And when the robot module follows the patrol path, it conducts surveillance activities, such as sensing and detecting objects or activity, and triggering an alert when a suspicious object or activity is detected. Examples of alerts can include projecting sounds or lights by the robot module itself, as well as triggering remote notifications through a notification system, such as by triggering an alert through a network to an onsite or remote security entity or personnel (e.g. application notification, text message, email, direct message, phone call, etc.).

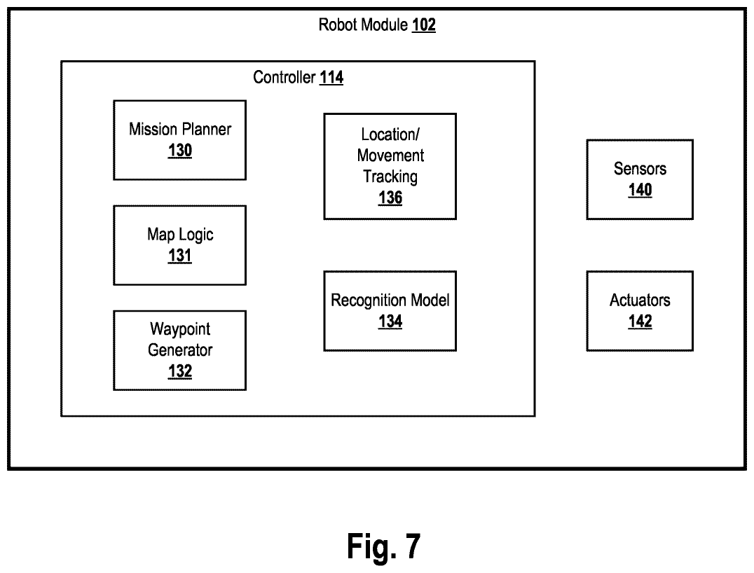

FIG. 7 conceptually illustrates componentry of a robot module, in accordance with implementations of the disclosure.

The robot module includes a controller 114, which can include hardware and software configured to control the operation of the robot module 102, including its movements as described herein. The controller 114 includes a mission planner 130 that generates paths for the robot module to traverse, as described herein. The mission planner 130 may access a map logic 131 to retrieve a map of a given area for which to generate paths, and/or provide updates to a given map. The mission planner 130 may access a waypoint generator 132 to generate waypoints for the robot module to navigate in order to traverse, at least approximately, a given path.

The robot module includes various sensors 140 that sense characteristics of the local environment in which the robot module is disposed, and/or characteristics of the robot module's movements or location. In some implementations, sensor data generated by one or more of the sensors 140 is processed by a recognition model 134 to enable recognition of objects in the local environment, such as curbs, roads, parking lot surfaces, vehicles (e.g. car, truck, motorcycle, etc.), persons, trash, etc. In some implementations, the sensor data and/or output of the recognition model 134 is used by a location/movement tracking logic 136 to determine the location and/or movement of the robot module 102. It will be appreciated that the determined location and/or movement of the robot module can be used as feedback to the global planner and the local planner, to enable continued generation of waypoints and velocities in accordance with the implementations of the present disclosure.

The robot module 102 further includes various actuators 142, which are controlled to move the robot module 102 according to the generated velocities by the local planner.

The robot module 102 may include one or more antennas, and can include cameras integrated into the body regions. In some embodiments, the cameras may be integrated to the sides of the outer body of the robot module to enable a 360 degree view. In one configuration, the top portion of the body may open to expose or grant access to electronics associated with the controller 114, electronics for interfacing with batteries of the sweeper module in the robot module 102, and other devices. Some electronics related devices may include processors, microcontrollers, system-on-a-chip processors, application specific integrated circuits (ASICs), memory modules, hard drives, solid state drives, network interface cards, radio communication devices, cellular transceivers, associated operating systems, controller boards, lights, plugs, circuit boards, connection wiring, and associated assemblies.

Other devices, without limitation, may include (without limitation) control systems for cameras, depth cameras, radar, LIDAR, motion sensors, depth sensors, ultrasonic sensors, heat sensors, motion sensors, strain sensors, motor sensors, locking sensors, lifting sensors, docking sensors, and other operational or interfacing sensors. In some embodiments, the wheel configuration can be interchanged, depending on the surface the robot is designed autonomously move about. For example, some wheels may be off-road if the vehicle is used on dirt roads or on farms, or harder surface wheels used in parking lots or smooth surface. In other embodiments, instead of wheels, loop rubber tracks can be used for more off-road operation.

Though in implementations of the disclosure described above, a robot module 102 has been discussed, it will be appreciated that in other implementations, other types of exchangeable modules having different functions can be attached to the robot. For example, a lift mechanism of the robot can be used to attach and retain interchangeable modules/attachments for performing different work functions. The exchangeable modules are physical apparatus structures that may each be configured to perform a unique task, e.g., steam cleaning, vacuuming, grass cutting, polishing, buffing, driveway and/or street cleaning (e.g., sweeping), package grasping and/or moving, etc. In some embodiments, the interchangeable attachments may be configured to perform complementary tasks. For example, for cleaning a floor, the first interchangeable attachment may be configured to vacuum the floor and the second interchangeable attachment may be configured to steam clean the floor.

In some implementations, the interchangeable attachments may be automatically loaded and unloaded from the robot one or more dock assemblies (or docking stations or base stations). The loading and unloading may be performed autonomously, with the robot automatically aligning itself and loading or unloading an interchangeable attachment as needed to accomplish the job assignment that the robot has been programmed to perform.

In some embodiments, the vertical movement of attachments achieved via a lift mechanism of the robot may be utilized as part of performing a task and/or to accommodate interchangeable attachments of different sizes. For example, in the case of a sweeper module the lift mechanism can be utilized to lift the sweeper module to a height required to remove the sweeper module from the dock assembly. The lift mechanism can also be used to lower the sweeper module to the appropriate height for carrying out sweeper operations, such as a height at which the brushes of the sweeper module fully contact the floor.

In some implementations, the robot includes a controller that is configured to control the autonomous functions of the robot. For example, the controller can control the motors which effect movement of the wheels of the robot to move the robot in its operations, such as to control movement of the robot over the sweeper module, and move autonomously along a path to capture debris into the container of the sweeper module. Further, the controller can control the robot's lift mechanism to lower the lift frame over the sweeper module to connect the alignment pegs with the alignment holes, control the locking mechanism to secure the lift frame to the sweeper module, and control the lift mechanism to raise the lift frame along with the sweeper module toward the interior space of the robot. It will be appreciated that the controller may control these operations in reverse so as to lower the lift frame along with the sweeper module, to seat the sweeper module onto the alignment platform, unlock the sweeper module so as to release the sweeper module, control the lift mechanism to raise the lift frame without the sweeper module, and move the robot off of the dock assembly while leaving the sweeper module at the dock assembly, for example, to allow the sweeper module to charge its battery or be serviced otherwise.

It will be appreciated that in some implementations, the robot includes a battery for powering its motors, lift mechanism, sensory systems, and other electronic systems. The sweeper module can also include a battery for powering the sweeper module, such as powering rotation of its brushes. In some implementations, a battery controller handles sharing of power between the robot's battery and the sweeper module's battery. The battery controller can be implemented as part of the robot or the sweeper module, or partially implemented on both the robot and the sweeper. In some implementations, power from the sweeper module's battery can be shared to the robot to, for example, charge the robot's battery, power the robot's motors, lift mechanism, locking mechanism, sensors, communications, etc. Likewise, in some implementations, power from the robot's battery can be shared to the sweeper module to, for example, charge the sweeper module's battery, power the sweeper module's brushes, etc.

In some implementations, the battery of the sweeper module is significantly larger than the battery of the robot, as the sweeper module is retained at the docking station and subject to charging for greater periods of time. Hence, the battery of the sweeper module can be implemented as the primary power source for the sweeper module as well as the robot, and therefore used to power the functions of both units.

In some implementations, when the sweeper module is connected to a docking station, and the robot is connected to the sweeper module, then the battery controller can route power to effects charging of one or both of the sweeper module's battery and the robot's battery. It will be appreciated that the battery controller routes power received from the docking station through the sweeper module to the robot, in order to provide power to the robot to charge its battery.

In some implementations, the robot includes a plurality of cameras and a global positioning system (GPS) for controlling movement of the robot by the controller. In some implementations, the robot uses one or more cameras to align with a visible code located at the dock system as described above, and images of the visible code are processed by the controller for guiding the robot to align with the dock system when the robot approaches the dock system for pickup or release of the sweeper module.

Advantageously, robots according to various embodiments disclosed herein may run indefinitely, with the robot constantly swapping batteries and interchangeable attachments as the need arises and as job assignments change. As a result, the robot may function as a home cleaning robot, a commercial cleaning robot, an outdoor robot, an indoor robot, etc. which may autonomously change its abilities without the need of human interaction (e.g., from grass cutting with a grass cutting attachment, to moving bins and crates of an adapter for supporting bins and crates, to cleaning driveways with a vacuum and/or sweeping attachment). An example of the operation of the robot is provided below. It will be appreciated that the sequence below may be performed in the order shown. In addition, omissions of certain actions and/or changes in the order of various actions are also contemplated.

The robot may start off at a charging base station with an interchangeable attachment (e.g., a sweeper module) locked to the main chassis or body of the robot through its retention system. The robot may start off with a power supply (e.g., a removable battery) already in place. The robot heads out of the charging base to perform its assignment (in this case sweeping). When the robot is finished with the assignment (finished sweeping a given area), or when the interchangeable attachment is filled to capacity (e.g., when a sweeper module is filled with debris) the robot will return to the base station or another designated drop area, and detach the interchangeable attachment. The detachment may occur via unlock and pushout of the attachment, or by dropping the attachment under the force of gravity. The robot aligns itself to the interchangeable attachment, or wherever the retention adapters are among the interchangeable attachments, moves towards the interchangeable attachment, centers itself (e.g., using sensors such as a camera) and the retention system locks/unlocks the interchangeable attachment as desired. When the robot approaches the base/charging station, at a certain distance it starts a docking procedure.

The robot maintains a docking distance from the base station to help itself align to the back of the modular box as well as to the retention system before the robot docks. This docking procedure exists in both retaining and detaching the interchangeable attachments at a designated area or a base/charging station. The base station may help guide the robot via sensors and buttons to dock at the base station and aligned with the retention system. In other words, the base station may provide guidance for the robot to return to the station. In addition, the station may include an actuator that shifts the position of the interchangeable attachment to align with the retention system of the robot. The robot may move towards and locate the base station with a variety of sensors, such as live feed cameras, infrared or other proximity sensors, ground sensors, or line detection sensors that are able to follow “tracks” which may be provided on the ground along the path which the robot is to traverse. The tracks may be, e.g., anything from tape that is sensed by the robot, paint sensors disposed or integrated into a surface, or sensors embedded at specific locations in the ground. The use of tracks in one embodiment is optional, since the robot will be able to use its cameras and sensors to navigate and avoid obstacles. The robot may use a variety of sensors such as live feed cameras and/or infrared or other proximity sensors to help locate, and load and unload the interchangeable attachments at a base station or other designated area.

The robot may move to an empty location (e.g., at the base station or at a designated area) and detach its interchangeable attachment. Preferably, this detachment occurs at the location the interchangeable attachment was originally picked up from, e.g., at the space left open when the component was earlier retained by the robot. The robot may then move to another interchangeable attachment for another task. For example, the robot may align itself with a steam cleaning interchangeable attachment located at the base station (e.g., next to or around the vacuum interchangeable attachment), and pick up the steam cleaning interchangeable attachment via the retention system, and then move away from base station to perform the steam cleaning task. In some other embodiments, both the vacuum attachment and the steam cleaning attachment may be loaded onto the robot such that vacuuming and steam cleaning maybe performed without requiring the robot to return to the base station to switch attachments.

The robot can navigate with the help of GPS, in addition to other location devices not positioned on the robot itself or the base station to help with returning to an interchangeable attachment for docking and undocking. These location devices may include Bluetooth beacons or infrared light emitters. In cases where the robot is equipped with a modular, removable power supply, the power supply may be unloaded and a new power supply may be loaded in a procedure similar to the unloading and loading of interchangeable attachments. For example, where the robot has performed various tasks and its attached battery is running low, the robot may: move to a base station containing a charged or charging battery, unload a depleted battery at the base station or designated area, and load another battery.

In cases where the robot is not equipped with a modular, removable power supply, the robot may use a variety of sensors to return to the base station for recharging. The robot may return to the base station to recharge, head off to finish its job, or remain at the base station depending on whether a job assignment has been completed. The robot may be charged while retaining an interchangeable attachment. For example, such charging may be performed via connectors built into the robot that send signals and power to both the interchangeable attachments and the robot's main computer system. In some embodiments, charging may occur without the robot retaining any interchangeable attachment.

It will be appreciated that the interchangeable attachment may be tracked by the robot using shape/color or design. Such tracking may be utilized to align to the robot for unloading and loading the interchangeable attachment.

It will be appreciated by those skilled in the art that various omissions, additions and modifications can be made to the processes and structures described above without departing from the scope of the invention. For example, it will be appreciated that the robot has been shown without any side panels or other housing around the functional illustrated components. In some embodiments, a housing or shell may be provided around the illustrated components e.g., to protect these functional components from collisions of external objects, weather, or other external phenomena that may damage these functional components.

In addition, the housing may maintain a consistent external appearance and size/shape to the robot, irrespective of the sizes of the interchangeable attachments or the number of retained attachments. This may provide aesthetic benefits and/or allow a consistent interface with other devices external to the robot (e.g., a base station) irrespective of modifications to the internal components or interchangeable attachments. In addition, while various components have been illustrated and discussed as being placed at different locations, it will be appreciated that the relative locations of the various compliments may be varied while still maintaining the functionality disclosed herein.

It is contemplated also that various combinations or sub-combinations of the specific features and aspects of the embodiments may be made and still fall within the scope of the description. Various features and aspects of the disclosed embodiments can be combined with, or substituted for, one another in order.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention could employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for autonomous navigation by a robot module, comprising:
receiving selection of a region of a map for coverage by the robot module;
responsive to receiving the selection, then generating a path for traversal by the robot module, the path including one or more back-and-forth raster patterns that enable coverage of the region by the robot module;
generating a plurality of waypoints along the path, the waypoints defining a sequence of target destinations for the robot module;
autonomously moving the robot module through the waypoints in sequence, wherein moving the robot module through the waypoints causes the robot module to substantially traverse the path.

2. The method of claim 1, wherein a spacing between adjacent passes of the back-and-forth raster patterns is set according to a user-selectable operational mode of the robot module.

3. The method of claim 2, wherein the robot module is configured to perform sweeping of a surface, and wherein the user-selectable operational mode is selected from a deep cleaning mode that sets a narrow spacing between the adjacent passes, and a spot cleaning mode that sets a wide spacing between the adjacent passes.

4. The method of claim 1, wherein a spacing between adjacent passes of the back-and-forth raster patterns is dynamically set in response to detected surface conditions by the robot module, the detected surface conditions being of a local environment in which the robot module is disposed that is represented by the selected region of the map.

5. The method of claim 4, wherein the dynamic setting of the spacing between the adjacent passes is configured so that when the detected surface conditions include higher amounts of debris, then the spacing is configured to be narrower, whereas when the detected surface conditions include lower amounts of debris, then the spacing is configured to be wider.

6. The method of claim 4, wherein the spacing between the adjacent passes is configured to be at a default setting, and wherein the dynamic setting of the spacing is configured to adjust the spacing to be narrower than the default setting in response to the detected surface conditions indicating an amount of debris.

7. The method of claim 4, wherein the detected surface conditions include a geographic region adjacent to a current pass being traversed by the robot module.

8. The method of claim 1, wherein generating the waypoints includes assigning waypoints along straight portions of the path and along turns in the path.

9. The method of claim 8, wherein the waypoints assigned along the straight portions have a first density, and wherein the waypoints assigned along the turns have a second density greater than the first density.

10. The method of claim 1, further comprising: providing a user interface through a display, wherein the selection of the region of the map is received through the user interface.

11. A non-transitory computer readable medium having program instructions embodied thereon that, when executed by at least one processor cause said at least one processor to perform a method for autonomous navigation by a robot module, the method including the following operations:
receiving selection of a region of a map for coverage by the robot module;
responsive to receiving the selection, then generating a path for traversal by the robot module, the path including one or more back-and-forth raster patterns that enable coverage of the region by the robot module;
generating a plurality of waypoints along the path, the waypoints defining a sequence of target destinations for the robot module;
autonomously moving the robot module through the waypoints in sequence, wherein moving the robot module through the waypoints causes the robot module to substantially traverse the path.

12. The non-transitory computer readable medium of claim 11, wherein a spacing between adjacent passes of the back-and-forth raster patterns is set according to a user-selectable operational mode of the robot module.

13. The non-transitory computer readable medium of claim 12, wherein the robot module is configured to perform sweeping of a surface, and wherein the user-selectable operational mode is selected from a deep cleaning mode that sets a narrow spacing between the adjacent passes, and a spot cleaning mode that sets a wide spacing between the adjacent passes.

14. The non-transitory computer readable medium of claim 11, wherein a spacing between adjacent passes of the back-and-forth raster patterns is dynamically set in response to detected surface conditions by the robot module, the detected surface conditions being of a local environment in which the robot module is disposed that is represented by the selected region of the map.

15. The non-transitory computer readable medium of claim 14, wherein the dynamic setting of the spacing between the adjacent passes is configured so that when the detected surface conditions include higher amounts of debris, then the spacing is configured to be narrower, whereas when the detected surface conditions include lower amounts of debris, then the spacing is configured to be wider.

16. The non-transitory computer readable medium of claim 14, wherein the spacing between the adjacent passes is configured to be at a default setting, and wherein the dynamic setting of the spacing is configured to adjust the spacing to be narrower than the default setting in response to the detected surface conditions indicating an amount of debris.

17. The non-transitory computer readable medium of claim 14, wherein the detected surface conditions include a geographic region adjacent to a current pass being traversed by the robot module.

18. The non-transitory computer readable medium of claim 11, wherein generating the waypoints includes assigning waypoints along straight portions of the path and along turns in the path.

19. The non-transitory computer readable medium of claim 18, wherein the waypoints assigned along the straight portions have a first density, and wherein the waypoints assigned along the turns have a second density greater than the first density.

20. The non-transitory computer readable medium of claim 11, wherein the method further includes: providing a user interface through a display, wherein the selection of the region of the map is received through the user interface.
